(19) United States
(12) Patent Application Publication
(10) Pub. No.: US 2007/0080213 A1
(43) Pub. Date: Apr. 12, 2007

(54) Aggregate electronic change saving method

(76) Inventors: Lloyd Trevillyan Workman, San Diego, CA (US); Justin Robert Lindholm, San Diego, CA (US)

Correspondence Address: LLOYD T WORKMAN, 4863 COCONINO WAY, SAN DIEGO, CA, 92117, US

(21) Appl. No.: 11/325,910

(22) Filed: Jan. 5, 2006

Related U.S. Application Data
(60) Provisional application No. 60/726,413, filed on Oct. 12, 2005.

(51) Int. Cl. G06K 5/00; G07F 19/00; G06Q 20/00; G06Q 40/00

(52) U.S. Cl. 235/380; 235/379; 705/39; 705/16

(57) ABSTRACT

A method for automatic electronic saving of change over the whole dollar amount of purchases using cash, debit cards, credit cards, or any combination of cash, debit cards, and credit cards. For cash purchases, change from the purchase is transferred into the user's designated account by transferring the change from the purchase into the user's account through a point of sale machine. For debit card and credit card purchases, the automatic savings transfers occur through the user's checking and/or credit card account. The purchase is rounded up to the nearest whole dollar amount or other amount the user elects to have purchases rounded up to. The difference is automatically transferred into a separate account. The method works best if all of the monies saved from the method are transferred into an interest bearing account elected by the user that is separate from the users normal checking and saving accounts.

### CROSS-REFERENCE TO RELATED APPLICATION

This application claims the benefit of provisional patent application Ser. No. 60/726,413, filed Oct. 12, 2005 by the present inventor.

### FEDERALLY SPONSORED RESEARCH

Not Applicable

### SEQUENCE LISTING

Not Applicable

### BACKGROUND OF THE INVENTION

1. Field of Invention

The present invention relates to financial transactions. More particularly, the present invention relates to purchases made using debit cards, credit cards, and cash.

2. Prior Art

Financial Institutions currently offer a user options to save change automatically with debit card purchases. Purchases made with the users debit card are rounded up to the nearest whole dollar amount made with their debit card, with the difference being transferred from the user's checking account into the user's corresponding savings account. This method makes saving automatic for each debit purchase the user makes with change in cents over the whole dollar amount of the purchase price. Current methods of saving change heretofore known suffer from a number of disadvantages:

(a) Users often use money in their savings account as reserve funds for their checking account and transfer funds frequently from their savings account to the corresponding checking account. In this case, as soon as funds are needed in the user's checking account, the user will deposit the money that has been credited to the savings account back into the corresponding checking account. Transferring the sum of money that has been rounded up and transferred into the user's savings account, back into the user's corresponding checking account, nullifies the main tangible benefit to the user of this saving method. The main flaw with the current electronic saving method available to consumers is that monies transferred into the users savings account are easily transferred back into the user's checking account where the funds originated.

(b) The current method of electronic change saving does not provide an option for users to save change received from cash transactions.

(c) There is no option for users to elect to limit access to the account into which the sum total of change savings is deposited.

(d) The current method of change saving does not provide an option for the user to save a sum of money greater than the difference rounded up to the whole dollar amount of the purchase price.

Change counting and sorting machines provide users with a method to have change sorted, counted, and exchanged for paper currency or debit gift card. Change counting and sorting machines heretofore know suffer from a number of disadvantages:

(a) While accumulating change, user's run the risk of losing physical change as change accumulates.

(b) Users do not gain interest on their change while in the process of accumulating physical change.

(c) Users are usually charged a fee for having their change sorted, counted, and converted into paper currency.

3. Objects and Advantages

Several objects and advantages of the present invention relating to electronic change saving are:

(a) to provide a method for a user to save change automatically;

(b) to provide the user with an option to save change automatically into an account separate from the users savings account that cannot be easily accessed and where the user has the option to elect limited access to funds accumulated through the saving method for a specified length of time;

(c) to provide a method of saving change where the user has the option to save an amount of money greater than the difference rounded up to the nearest whole dollar amount of the transaction;

(d) to provide a method of saving change that has a minimal economic impact on the user;

(e) to provide a method of saving change that is safe and secure for the user;

(f) to provide a method of saving that will only happen with the use of the change saving method;

(g) the method helps lessen the amount of physical change the user accumulates from financial transactions;

(h) Lessens the risk of the user losing change;

(i) Provides method for the user to deposit change from purchases in an interest bearing account as change accumulates rather than having to wait until accumulated change is deposited into the user's designated interest bearing account;

(k) Provides a method to continually count and sort change.

Further objects and advantages of my invention are: to provide an easy and effective way to save money that has a minimal economic impact on the day to day life of the user that is currently not available to potential users. In banking today, many people have automatic withdrawal for many types of payments. Also, financial institutions, banks, credit card companies, and retailers make spending money easy and convenient. Most people, however, do not have money being regularly transferred into their account aside from their paycheck. There are very few options available for potential users to save money electronically that have a minimal economic impact on the day to day life of the user. However, if the user of the method is able to save change for a month, a year, or ten years, in an interest bearing account, the user will receive a substantial economic benefit that will increase exponentially over time.

### SUMMARY

The invention is a method that allows users to electronically transfer change from purchases in the amount of the difference between the purchase price and the purchase price rounded up to the nearest whole dollar amount, or a selected amount greater than the difference between the purchase price and the purchase price rounded up to the nearest whole dollar amount. The change savings is deposited into a designated account into which monies saved through the use of the method are deposited. The method allows change from purchases using cash, debit card, credit card, or any combination of cash, debit card, and credit card, to be transferred electronically into the user's designated account. The method of saving will give the greatest benefit to user and financial institutions that employ the use if the method if the user has monies saved from the use of the method deposited into an interest bearing account separate from the user's regular checking and savings account.

### DRAWINGS FIGURES

FIG. 1 shows how function 1 of the invention is applied to purchases made using a debit card account, or credit card account.

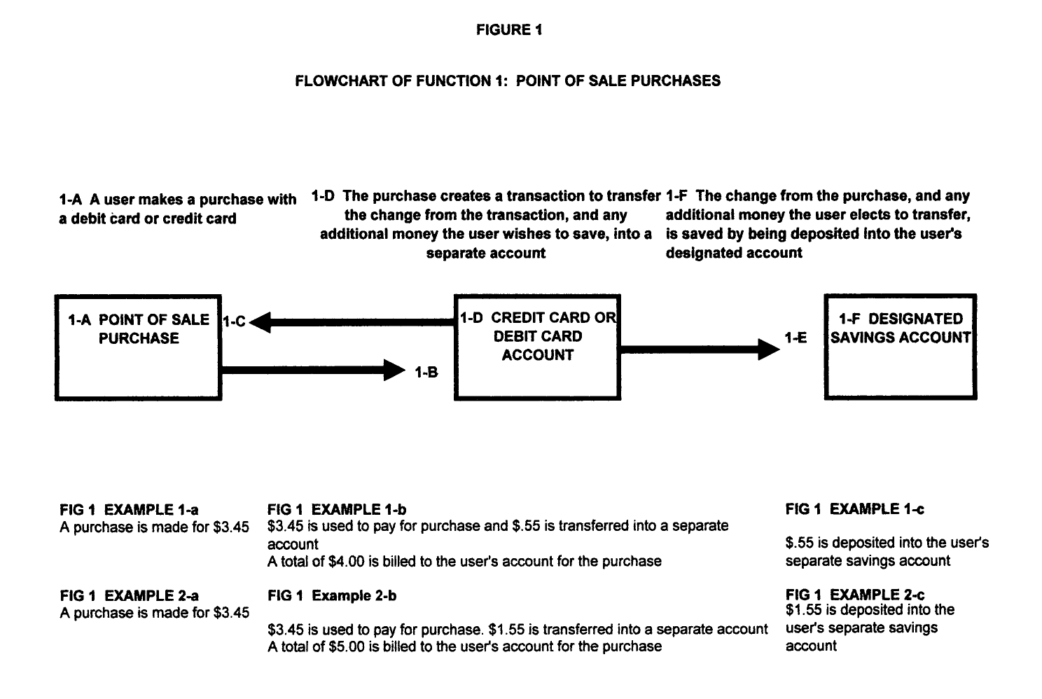

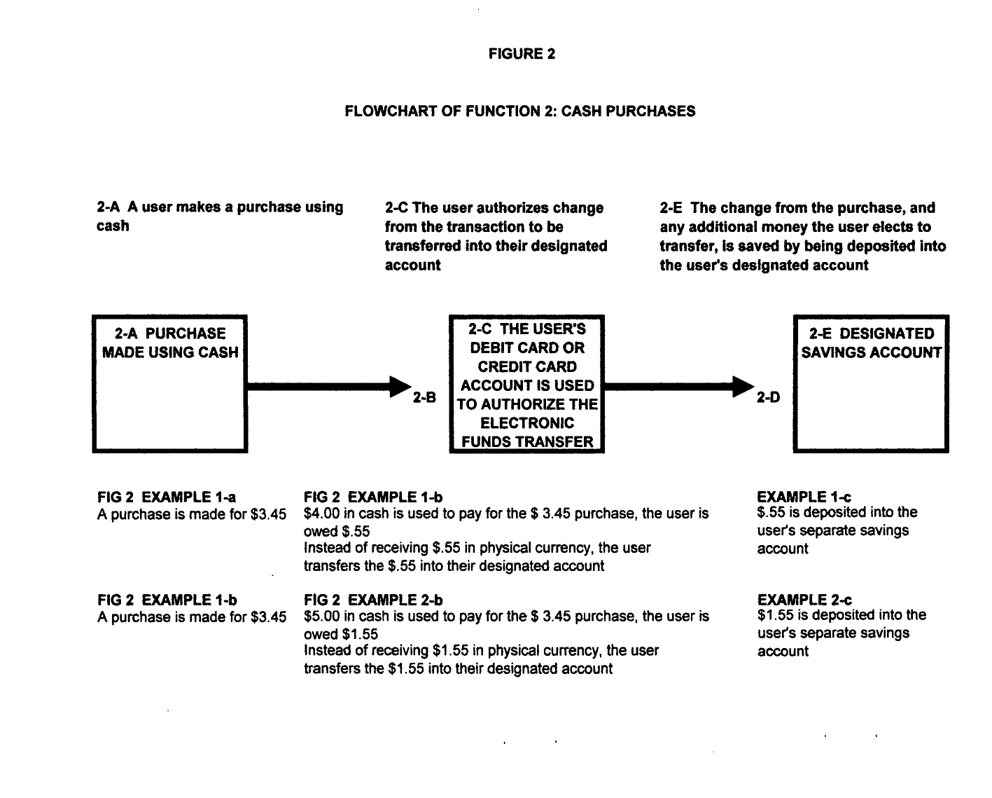

1-A a purchase is made at a point of sale machine using a debit card or credit card account that is set up for use of the method.

1-B the user's debit card or credit card is used to pay for the purchase, and create the transaction to save change from the purchase.

1-C the correct amount of money is transferred from the user's debit or credit account, to the account of the point of sale machine where the purchase was made.

1-D shows that the correct amount of money is transferred for the purchase and for the amount of money that the user wishes to transfer into a separate savings account.

1-E shows a transaction is created to transfer change from the point of sale transaction, and any additional money the user wishes to transfer, into the user's designated savings account.

1-F Change from the point of Sale transaction, and any additional money, is deposited into the user's designated account.

FIG. 2 shows how function 2 of the invention is applied to purchases made using cash.

2-A a purchase is made with cash and the user wishes to have change from the transaction transferred into a separate account instead of receiving physical change in currency for the transaction.

2-B The user authorizes change from the transaction to be electronically transferred to their designated account by using their debit card or credit card account that has been set up for use of the method. The user will swipe their card and/or use their account number to authorize the transaction.

2-C The user authorizes change from the transaction to be transferred into their designated account. The users debit card or credit card account is used to authorize the electronic funds transfer.

2-D a transaction is created to transfer change from the point of sale transaction, and any additional money the user wishes to transfer, to the user's designated savings account.

2-E shows the change from the point of sale transaction, and any additional money, is deposited into the users designated account.

### DETAILED DESCRIPTION-PREFERRED EMBODIMENT

The preferred embodiment of the method consists of two functions that that can work independently of one another, but works best when combined, with monies saved from each function deposited into the same account.

Function 1 allows the user to transfer change in cents over the whole dollar amount from cash purchases, and any additional money the user elects to transfer in addition to the change in cents over the whole dollar amount of the purchase, into the users designated account into which money saved through the use of the method is deposited. The method is made available with the use of a point of sale machine that allows debit card transactions. The user of the method swipes their debit or credit card to allow the change from the cash transaction credited to the user's designated account.

Function 2 allows users to save change from electronic transactions made with the user's debit card, credit card, or the user's debit card and credit card. The change saving occurs automatically with every transaction made with the user's debit card and/or credit card. All transactions made with the user's debit card and/or credit that have been set up to employ the use of this method, are rounded up to the nearest whole dollar amount, or other amount over the purchase price elected by the user, with the difference being deposited into the user's designated account.

The preferred use of the invention is to have monies from Function 1 and Function 2 transferred into the same corresponding account. The greatest benefit to the user and to the financial institution that offers the use of the method is to have monies saved using both functions deposited into an interest bearing account, separate from the users checking and savings account that allows for easy transfers, that the user elects not to be able to use for a specified length of time or until a specified amount of money is saved. The main benefit for the user of having monies deposited in an interest bearing account that the user elects not to be able to use for a specified length of time is that interest gained on the sum total of the monies and interest transferred into the designated account is accumulated and compounded over time.

Operation:

The method of saving change from financial transactions is utilized by programming this option into the existing software of the financial institutions that use the method. The groundwork for the implementation of the saving method has already been created. To employ the use of the method, alterations are made to point of sale machine networks, and to the financial transaction software of banks and credit card companies that employ the use of the method.

To facilitate saving change from cash transactions, point of sale machine software is altered to allow change from cash transactions to be transferred into the users designated account. For debit card and credit card transactions, the banking software is altered to allow the automatic transfer of change from debit cards and credit cards to be transferred into the users designated account. The invention must be employed with the use of the financial transaction systems of the financial institutions and establishments that elect use of the invention.

For cash purchases, remaining change in cents over the whole dollar amount of purchases, and any additional monies the user wishes to deposit into the designated account, are electronically transferred into the user's designated account at retail establishments that use software and technology that allows the method to be integrated into that retail establishment's electronic financial transaction system. With necessary software alterations in place, change from cash transactions are electronically transferred by swiping the user's debit card or credit card and authorizing remaining change in cents over the whole dollar amount of the purchase, and any additional change from the cash purchase that the user elects to have deposited into the user's designated account, to be transferred into the user's designated account.

For transactions made with the user's debit card or credit card of financial institutions that employ the use of the method for every purchase where the purchase price does not round up to a whole dollar amount, the retail establishment will be credited with the exact amount of the purchase. A transaction is then created to transfer the difference between the purchase price and the nearest whole dollar amount rounded up, and any additional sum of money the user wishes to transfer into the designated account, from the user's debit card or credit card account into to the user's designated account. Allowing the method to be used with purchases made by the user with debit cards, credit cards, or debit cards and credit cards, is a matter of altering financial transaction software to make an automatic transfer to the user's designated account with every transaction, unless the transaction is already in a whole dollar amount, in which case no transaction would be created unless otherwise elected by the user.

For financial institutions that offer customers the use of this invention, whether with cash purchases, electronic purchases, or both, the use of the invention can be offered in conjunction with checking accounts, savings accounts, credit card accounts, investment accounts, or all of the above. The invention can also operate as a means of selling additional accounts for the monies accumulated from the invention to be deposited into.

Conclusion, Ramifications, and Scope

Accordingly, the reader will see that, according to the invention, I have provided an easy and effective way to save change in cents, and any additional money the user wishes to save, from purchases made with cash, debit cards, and credit cards. In addition, the method has additional advantages in that:

It provides a method where a user not yet old enough to have a debit card or credit card could use the method to save all change from cash transactions;

It provides the financial institution that employs the use of the method the opportunity to sell additional products to the user, such as an investment account that monies saved through the method are deposited into;

It provides a way to continually count and sort change that may have otherwise been lost;

It provides a competitive advantage for the financial institutions that employ the use of the method.

Although the description above contains many specificities, these should not be construed as limiting the scope of the invention but as merely providing illustrations of some of the presently preferred embodiments of this invention. For example, the user could elect to have all purchases rounded up to the nearest whole dollar amount in increments of 5 or 10 dollars to increase the amount of money saved with each purchase. Also, all monies, or a portion of monies, saved through the use of the method could be transferred to a charity instead of a user's designated account.

Thus the scope of the invention should be determined by the appended claims and their legal equivalents, rather than by the examples given.

1. A method of electronically saving change in cents over the whole dollar amount of a purchase price, and any additional amount of money the user wishes to save in addition to change in cents over the whole dollar amount of the purchase price, by having the change in cents over the whole dollar amount of a purchase price, and any additional amount of money the user wishes to save in addition to change in cents over the whole dollar amount, transferred into separate account designated by the user.

2. A method of electronically saving change in cents over the whole dollar amount of the purchase as recited in claim 1 whereby change from cash purchase transactions are transferred into the users designated account.

3. A method of electronically saving change in cents over the whole dollar amount of the purchase as recited in claim 1 whereby change in currency from debit card purchase transactions are automatically electronically transferred into the user's designated account.

4. A method of electronically saving change in cents over the whole dollar amount of purchases as recited in claim 1 whereby change from credit card purchase transactions are automatically electronically transferred into the user's designated account.

5. A method of electronically saving change in cents over the whole dollar amount of a purchase price as recited in claim 1 whereby monies transferred using said method accumulate in a specified account.

6. A method of electronically saving change in cents over the whole dollar amount of a purchase price as recited in claim 1 whereby money is saved with minimal economic impact on said user.

7. A method of electronically saving change in cents over the whole dollar amount of a purchase price as recited in claim 1 whereby said user has the option to save change automatically into an account separate from said user's checking account that cannot be easily accessed and where the user has the option to elect not to be able to access funds accumulated through said saving method for a specified length of time.

8. A method of electronically saving change in cents over the whole dollar amount of a purchase price as recited in claim 1 whereby monies accumulated through employ of said method by said user increase with interest gained and compounded in the user's specified account.
